(19) United States
(12) Patent Application Publication
(10) Pub. No.: US 2025/0279951 A1
(43) Pub. Date: Sep. 4, 2025

(54) SIGNALING TRACE CONTROL IN A MOBILE COMMUNICATION SYSTEM

(71) Applicant: Tencent Technology (Shenzhen) Company Limited, Shenzhen (CN)

(72) Inventor: Jiaxin FENG, Shenzhen (CN)

(73) Assignee: Tencent Technology (Shenzhen) Company Limited, Shenzhen (CN)

(21) Appl. No.: 19/210,525

(22) Filed: May 16, 2025

Related U.S. Application Data
(63) Continuation of application No. PCT/CN2023/130282, filed on Nov. 7, 2023.

(30) Foreign Application Priority Data
Jan. 19, 2023 (CN) 202310090973.8

(51) Int. Cl. H04L 43/10; H04W 4/20; H04W 8/18; H04W 24/08

(52) U.S. Cl. CPC H04L 43/10; H04W 4/20; H04W 8/18; H04W 24/08

(57) ABSTRACT

In a communication method, a signaling tracing request to trace specified content of user equipment in a mobile communication system is received. A tracing identifier of the user equipment associated with the signaling tracing request is determined. An internal identifier in the mobile communication system for the user equipment is obtained. Start indication information is transmitted to a network-side device. The start indication information includes the tracing identifier, the internal identifier in the mobile communication system, and content information that indicates the specified content. The start indication information initiates signaling tracing. From the network-side device, content that is traced is received based on the internal identifier in the mobile communication system and the specified content. The content is marked with the tracing identifier.

### RELATED APPLICATIONS

The present application is a continuation of International Application No. PCT/CN2023/130282, filed on Nov. 7, 2023, which claims priority to Chinese Patent Application No. 202310090973.8, filed on Jan. 19, 2023. The entire disclosures of the prior applications are hereby incorporated by reference.

### FIELD OF THE TECHNOLOGY

This application relates to the field of computer and communication technologies, including a communication method.

### BACKGROUND OF THE DISCLOSURE

In a mobile communication system, a signaling procedure of user equipment (UE) includes a plurality of network elements (for example, an access network element and a core network element) of the mobile communication system, relates to a plurality of protocols, and includes interaction of a plurality of pieces of signaling. A network environment of the mobile communication system is complex. Therefore, to improve network reliability, a corresponding field of standard signaling usually needs to be analyzed to find out a cause of a fault, such as a high call drop rate, a handover failure, or a traffic exception, and further the network is optimized in a targeted manner, so as to improve user experience. During analysis of interaction signaling, how to reduce unnecessary signaling overheads in the mobile communication system is a technical problem to be resolved.

### SUMMARY

Aspects of this disclosure provide communication methods and an apparatus to reduce additional signaling overhead caused inside a network during signaling tracing.

Examples of technical solutions of this disclosure may be implemented as follows:

An aspect of this disclosure provides a communication method. A signaling tracing request to trace specified content of user equipment in a mobile communication system is received. A tracing identifier of the user equipment associated with the signaling tracing request is determined. An internal identifier in the mobile communication system for the user equipment is obtained. Start indication information is transmitted to a network-side device. The start indication information includes the tracing identifier, the internal identifier in the mobile communication system, and content information that indicates the specified content. The start indication information initiates signaling tracing. From the network-side device, content that is traced is received based on the internal identifier in the mobile communication system and the specified content. The content is marked with the tracing identifier.

An aspect of this disclosure provides a communication method. Start indication information is received from a signaling tracing control device. The start indication information includes a tracing identifier of user equipment, an internal identifier in a mobile communication system for the user equipment, and content information that indicates specified content of the user equipment to be traced. Tracing is performed based on the internal identifier in the mobile communication system and the content information that indicates the specified content. Traced content is marked with the tracing identifier. The marked content is transmitted to the signaling tracing control device.

An aspect of this disclosure provides an apparatus. The apparatus includes processing circuitry configured to receive a signaling tracing request to trace specified content of user equipment in a mobile communication system. The processing circuitry is configured to determine a tracing identifier of the user equipment associated with the signaling tracing request. The processing circuitry is configured to obtain an internal identifier in the mobile communication system for the user equipment. The processing circuitry is configured to transmit start indication information to a network-side device. The start indication information includes the tracing identifier, the internal identifier in the mobile communication system, and content information that indicates the specified content. The start indication information initiates signaling tracing. The processing circuitry is configured to receive, from the network-side device, content that is traced based on the internal identifier in the mobile communication system and the specified content. The content is marked with the tracing identifier.

In technical solutions provided in some aspects of this disclosure, when the signaling tracing request transmitted by the user equipment is received, the tracing identifier specific to the user equipment is determined; and then the start indication information configured for starting signaling tracing is transmitted to the network-side device, to indicate the network-side device to trace the specified content based on the identifier used inside the mobile communication system and the information about the specified content and mark the traced content with the tracing identifier. In this way, necessary tracing information configuration (that is, the tracing identifier of the user equipment, the identifier used inside the mobile communication system, and the information about the specified content to be traced) is transmitted to the network-side device when tracing starts. In addition, because the content traced by the network-side device is already marked with the tracing identifier, the network-side device does not need to add the tracing identifier to interaction signaling. Thus, additional signaling overheads caused inside a network during signaling tracing can be reduced.

The foregoing general descriptions and the following detailed descriptions are merely for illustration and explanation purposes and are not intended to limit this disclosure.

### BRIEF DESCRIPTION OF THE DRAWINGS

FIG. 1 is a diagram of a system architecture to which technical solutions in aspects of this disclosure are applicable.

FIG. 2 is a flowchart of a communication method according to an aspect of this disclosure.

FIG. 3 is a flowchart of a communication method according to an aspect of this disclosure.

FIG. 4 is a diagram of a system architecture according to an aspect of this disclosure.

FIG. 5 is a schematic flowchart of interaction between a signaling tracing controller and a base station and between the signaling tracing controller and a core network according to an aspect of this disclosure.

FIG. 6 is a diagram of obtaining a globally unique identity of a user and a globally unique temporary identity of the user according to an aspect of this disclosure.

FIG. 7 is a schematic flowchart of updating a globally unique temporary identity of a user according to an aspect of this disclosure.

FIG. 8 is a block diagram of a communication apparatus according to an aspect of this disclosure.

FIG. 9 is a block diagram of a communication apparatus according to an aspect of this disclosure.

FIG. 10 is a diagram of a structure of a computer system adapted to implement an electronic device according to an aspect of this disclosure.

### DETAILED DESCRIPTION

Example implementations are described in a more comprehensive manner with reference to accompanying drawings. However, the example implementations can be implemented in various forms, and are not to be construed as being limited to only these examples. On the contrary, the purpose of providing the implementations is to make this disclosure more comprehensive and complete, and to convey the concept of the example implementations to a person skilled in the art. Further, the descriptions of the terms are provided as examples only and are not intended to limit the scope of the disclosure.

In addition, features, structures, or characteristics described in this disclosure may be combined in one or more aspects in any proper manner. In the following descriptions, many specific details are provided to provide a thorough understanding of the aspects of this disclosure. However, a person skilled in the art is to be aware that, during implementation of technical solutions in this disclosure, not all detailed features in the aspects need to be used, one or more specific details may be omitted, or another method, element, apparatus, step, or the like may be used.

The block diagrams shown in the accompanying drawings are merely functional entities and do not necessarily correspond to physically independent entities. To be specific, the functional entities may be implemented in a software form, or in one or more hardware modules or integrated circuits, or in different networks and/or processor apparatuses and/or microcontroller apparatuses.

The flowcharts shown in the accompanying drawings are merely example descriptions, do not need to include all content and operations/steps, and do not need to be performed in the described orders either. For example, some operations/steps may be further divided, while some operations/steps may be combined or partially combined. Therefore, an actual execution order may change according to an actual situation.

“A plurality of” mentioned in this specification means two or more. The term “and/or” describes an association between associated objects, and indicates that three relationships may exist. For example, A and/or B may indicate the following three cases: Only A exists, both A and B exist, and only B exists. The character “/” indicates an “or” relationship between associated objects.

One or more modules, submodules, and/or units of the apparatus can be implemented by processing circuitry, software, or a combination thereof, for example. The term module (and other similar terms such as unit, submodule, etc.) in this disclosure may refer to a software module, a hardware module, or a combination thereof. A software module (e.g., computer program) may be developed using a computer programming language and stored in memory or non-transitory computer-readable medium. The software module stored in the memory or medium is executable by a processor to thereby cause the processor to perform the operations of the module. A hardware module may be implemented using processing circuitry, including at least one processor and/or memory. Each hardware module can be implemented using one or more processors (or processors and memory). Likewise, a processor (or processors and memory) can be used to implement one or more hardware modules. Moreover, each module can be part of an overall module that includes the functionalities of the module. Modules can be combined, integrated, separated, and/or duplicated to support various applications. Also, a function being performed at a particular module can be performed at one or more other modules and/or by one or more other devices instead of or in addition to the function performed at the particular module. Further, modules can be implemented across multiple devices and/or other components local or remote to one another. Additionally, modules can be moved from one device and added to another device, and/or can be included in both devices.

The use of “at least one of” or “one of” in the disclosure is intended to include any one or a combination of the recited elements. For example, references to at least one of A, B, or C; at least one of A, B, and C; at least one of A, B, and/or C; and at least one of A to C are intended to include only A, only B, only C or any combination thereof. References to one of A or B and one of A and B are intended to include A or B or (A and B). The use of “one of” does not preclude any combination of the recited elements when applicable, such as when the elements are not mutually exclusive.

In a mobile communication system, a complete signaling procedure of user equipment includes a plurality of network elements (for example, an access network element and a core network element) of the mobile communication system, relates to a plurality of protocols, and includes interaction of a plurality of pieces of signaling. A network environment of the mobile communication system is complex. Therefore, to improve network reliability, a corresponding field of standard signaling usually needs to be analyzed to find out a cause of a fault, such as a high call drop rate, a handover failure, or a traffic exception, and further the network is optimized in a targeted manner, so as to improve user experience.

To analyze interaction signaling of the user equipment, the interaction signaling of the user equipment in the mobile communication system needs to be traced. Two types of solutions for tracing signaling of user equipment are mainly provided in the related art: One is a tracing manner based on a single network element node, and the other is a full-link tracing manner. In the tracing manner based on a single network element node, the network element node records interaction signaling of user equipment only within the node, but an end-to-end full signaling procedure of the user equipment cannot be traced. In the full-link tracing manner, all interaction signaling and status information after user equipment connects to a network may be recorded, and further may be used in fault/exception analysis for the user equipment, and the like.

In the full-link tracing manner, tracing usually starts at an ingress network element of a mobile communication system, and a tracing identifier (ID) is generated at the ingress network element; and during interaction between internal network elements of a core network, interaction signaling carries the tracing ID, and an event and content of user equipment that need to be traced, to indicate information that needs to be traced, and the like. However, in this tracing manner, each time when interaction signaling of the user equipment reaches a network element, the network element needs to include the tracing information of the user equipment in the interaction signaling. The core network usually needs to serve tens of thousands to hundreds of thousands of users. When a large quantity of users needs to be traced and a large amount of tracing information needs to be transferred, a large quantity of additional signaling overheads are caused inside the core network.

Based on this, an aspect of this disclosure provides a new technical solution, so that a network-side device (for example, an access network element or a core network element) does not need to add a tracing identifier to interaction signaling, reducing additional signaling overheads caused inside a network during signaling tracing.

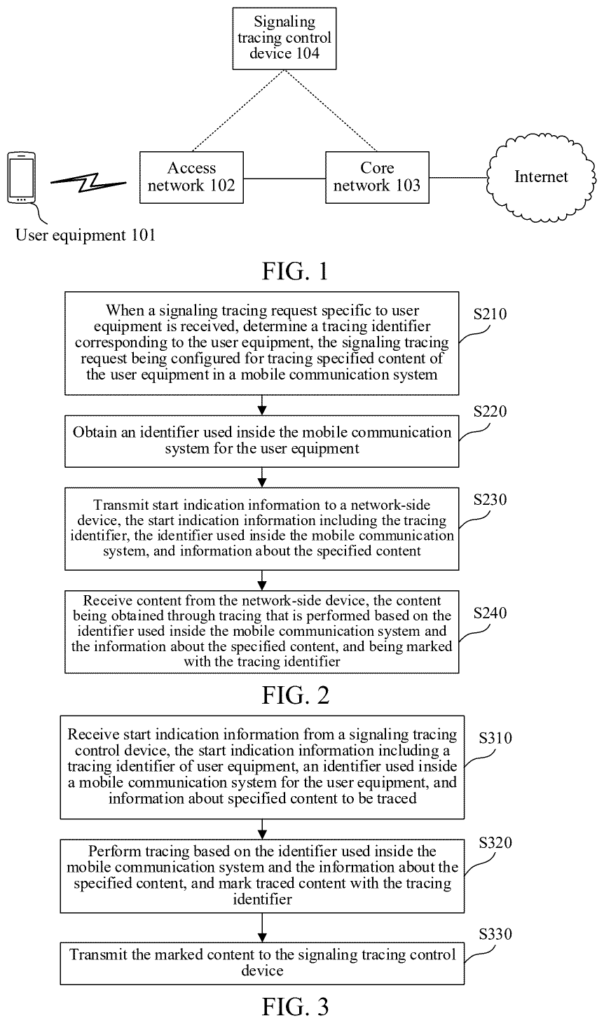

Specifically, as shown in FIG. 1, user equipment 101 connects to the Internet through an access network 102 and a core network 103, and continuously performs signaling interaction with the access network 102 and the core network 103 after connecting to the Internet. A signaling tracing control device 104 may interact with the access network 102 and the core network 103, to trace signaling of the user equipment 101.

For example, when receiving a signaling tracing request specific to the user equipment 101, the signaling tracing control device 104 generates a tracing identifier corresponding to the user equipment 101. The signaling tracing request is configured for tracing specified content of the user equipment 101 in a mobile communication system. In addition, the signaling tracing control device 104 may obtain an identifier used inside the mobile communication system for the user equipment 101, where the identifier used inside the mobile communication system may be an access network identifier and a core network identifier; and then may transmit first start indication information of signaling tracing to the core network 103, where the first start indication information includes the tracing identifier corresponding to the user equipment 101, the core network identifier of the user equipment 101, and information about the specified content to be traced. The signaling tracing control device 104 may further transmit second start indication information of signaling tracing to the access network 102, where the second start indication information includes the tracing identifier corresponding to the user equipment 101, the access network identifier of the user equipment 101, and the information about the specified content to be traced.

After that, the signaling tracing control device 104 may receive specified content traced by the access network 102 based on the access network identifier, and receive specified content traced by the core network 103 based on the core network identifier. Both the content may be marked with the tracing identifier of the user equipment 101, so that the signaling tracing control device 104 performs aggregation based on the tracing identifier of the user equipment 101, and the traced content may further be sorted by time.

The following describes implementation details of the technical solution in this aspect of this disclosure in detail.

FIG. 2 is a flowchart of a communication method according to an aspect of this disclosure. The communication method may be performed by a signaling tracing control device. With reference to FIG. 2, the communication method includes at least S210 to S240. A detailed description is as follows:

S210: When a signaling tracing request specific to user equipment is received, determine a tracing identifier corresponding to the user equipment, the signaling tracing request being configured for tracing specified content of the user equipment in a mobile communication system. For example, a signaling tracing request is to trace specified content of user equipment in a mobile communication system is received. A tracing identifier of the user equipment associated with the signaling tracing request is determined.

In some aspects, a tracing requester may trigger, by calling an application programming interface (API) or a set interface, transmission of the signaling tracing request specific to the user equipment to a signaling tracing control device. The tracing identifier is a tracing ID. A tracing ID is a unique identifier generated for a tracing task of a piece of user equipment. The specified content may be, for example, a communication protocol of concern for tracing, specific protocol field information, event information of concern, exception information, or alarm information.

S220: Obtain an identifier used inside the mobile communication system for the user equipment. For example, an internal identifier in the mobile communication system for the user equipment is obtained.

In some aspects, the identifier used inside the mobile communication system may include a core network identifier. In this case, during obtaining of the core network identifier of the user equipment, a core network identifier obtaining request may be transmitted to an identifier mapping management network element in a core network based on an identifier used outside the mobile communication system for the user equipment, and then the core network identifier of the user equipment returned by the identifier mapping management network element based on the core network identifier obtaining request is received.

In some aspects, the identifier used outside the mobile communication system for the user equipment may be a generic public subscription identifier (GPSI), a mobile subscription international ISDN number (MSISDN), a mobile phone number, or the like, where ISDN is integrated services digital network.

The identifier mapping management network element in the core network may be a unified data management (UDM) network element in a 5^{th} generation (5G) system, or may be a home subscriber server (HSS) in an evolved packet system (EPS).

The core network identifier of the user equipment is a globally unique identity, which may be a subscription permanent identifier (SUPI) in a 5G system, or may be an international mobile subscriber identity (IMSI) in a 4^{th} generation (4G) system.

In some aspects, the identifier used inside the mobile communication system further includes an access network identifier. In this case, during obtaining of the access network identifier of the user equipment, an access network identifier obtaining request may be transmitted to an access network identifier generating network element based on the core network identifier of the user equipment, and then the access network identifier of the user equipment returned by the access network identifier generating network element based on the access network identifier obtaining request is received.

In some aspects, the access network identifier generating network element may be an access and mobility management function (AMF) in a 5G system, or may be a mobility management entity (MME) in a 4G system.

The access network identifier of the user equipment is a globally unique temporary identity, which may be a globally unique temporary identity (GUTI) in a 4G system, or may be a 5G-GUTI in a 5G system.

S230: Transmit start indication information to a network-side device, the start indication information including the tracing identifier, the identifier used inside the mobile communication system, and information about the specified content, and the start indication information being configured for starting signaling tracing. For example, start indication information is transmitted to a network-side device. The start indication information includes the tracing identifier, the internal identifier in the mobile communication system, and content information that indicates the specified content. The start indication information initiates signaling tracing.

In some aspects, the network-side device may be a core network element. In this case, a process of transmitting the start indication information to the network-side device is specifically transmitting the start indication information to the core network element, the start indication information including the tracing identifier of the user equipment, the core network identifier of the user equipment, and the information about the specified content to be traced. In this case, the identifier used inside the mobile communication system includes the core network identifier.

In some aspects, the network-side device may be an access network element. In this case, a process of transmitting the start indication information to the network-side device is specifically transmitting the start indication information of signaling tracing to the access network element, the start indication information including the tracing identifier of the user equipment, the access network identifier of the user equipment, and the information about the specified content to be traced. In this case, the identifier used inside the mobile communication system includes the access network identifier.

In some aspects, the network-side device may be a core network element and an access network element. In this case, a process of transmitting the start indication information to the network-side device is specifically as follows: transmitting first start indication information to the core network element, the first start indication information including the tracing identifier of the user equipment, the core network identifier of the user equipment, and the information about the specified content to be traced; and transmitting second start indication information to the access network element, the second start indication information including the tracing identifier of the user equipment, the access network identifier of the user equipment, and the information about the specified content to be traced.

If the core network element that needs to receive the first start indication information is the access network identifier generating network element (for example, an AMF in a 5G system or an MME in a 4G system), the first start indication information may further include a callback address. The callback address is configured for: after the core network element reallocates the access network identifier to the user equipment, feeding back the reallocated access network identifier. For example, the core network element may call the callback address to feed back the reallocated access network identifier.

In some aspects, after receiving the access network identifier from the access network identifier generating network element, the signaling tracing control device may generate a tracing information update message, where the tracing information update message includes the tracing identifier and the reallocated access network identifier, and the access network identifier is reallocated to the user equipment. Then, the signaling tracing control device may transmit the tracing information update message to the access network element, where the tracing information update message is configured for indicating to trace the specified content of the user equipment based on the reallocated access network identifier. Even if the access network identifier is reallocated to the user equipment because the user equipment goes online or offline, the technical solution in this aspect can also ensure continuation of a signaling tracing process.

In some aspects, the signaling tracing request may further include information about a tracing time period. The tracing time period is configured for indicating a time period during which signaling needs to be traced for the user equipment. In this case, the signaling tracing control device may transmit the start indication information to the network-side device before the tracing time period starts.

S240: Receive content from the network-side device, the content being obtained through tracing that is performed based on the identifier used inside the mobile communication system and the information about the specified content, and being marked with the tracing identifier, that is, the content being traced based on the start indication information. For example, from the network-side device, content that is traced is received based on the internal identifier in the mobile communication system and the specified content. The content is marked with the tracing identifier.

In some aspects, if the network-side device includes the core network element, receiving the content traced by the network-side device based on the start indication information is receiving content traced by the core network element; and if the network-side device includes the access network element, receiving the content traced by the network-side device based on the start indication information is receiving content traced by the access network element.

After the specified content is traced based on the access network identifier and the core network identifier, the access network element and the core network element may mark the traced content with the tracing identifier corresponding to the user equipment, and then transmit the marked content to the signaling tracing control device for aggregation.

In some aspects, after receiving, from the network-side device, the content traced based on the start indication information, the signaling tracing control device may aggregate the traced content according to a set aggregation policy. The aggregation policy includes at least one of the following: aggregation based on the tracing identifier, or sorting of the traced content by time.

In some aspects, when a tracing end instruction specific to the user equipment is received, or when the tracing time period ends, the signaling tracing control device may transmit end indication information to the network-side device. The end indication information includes the tracing identifier, and is configured for ending signaling tracing. To be specific, the end indication information may indicate the network-side device to stop signaling tracing specific to the user equipment.

Therefore, in this disclosure, when the signaling tracing request transmitted by the user equipment is received, the tracing identifier specific to the user equipment is determined; and then the start indication information configured for starting signaling tracing is transmitted to the network-side device, to indicate the network-side device to trace the specified content based on the identifier used inside the mobile communication system and the information about the specified content and mark the traced content with the tracing identifier. In this way, necessary tracing information configuration (that is, the tracing identifier of the user equipment, the identifier used inside the mobile communication system, and the information about the specified content to be traced) is transmitted to the network-side device when tracing starts. In addition, because the content traced by the network-side device is already marked with the tracing identifier, the network-side device does not need to add the tracing identifier to interaction signaling. Thus, additional signaling overheads caused inside a network during signaling tracing can be reduced.

The technical solution in this aspect of this disclosure is described from the perspective of the signaling tracing control device in FIG. 2. Implementation details of the technical solution in this aspect of this disclosure are described again below from the perspective of the network-side device with reference to FIG. 3.

FIG. 3 is a flowchart of a communication method according to an aspect of this disclosure. The communication method may be performed by a network-side device. The network-side device may be an access network element, or may be a core network element. With reference to FIG. 3, the communication method includes at least S310 to S330. A detailed description is as follows:

S310: Receive start indication information from a signaling tracing control device, the start indication information including a tracing identifier of user equipment, an identifier used inside a mobile communication system for the user equipment, and information about specified content to be traced. For example, start indication information is received from a signaling tracing control device. The start indication information includes a tracing identifier of user equipment, an internal identifier in a mobile communication system for the user equipment, and content information that indicates specified content of the user equipment to be traced.

In some aspects, a network-side device may include a core network element. In this case, the identifier used inside the mobile communication system for the user equipment that is included in the start indication information received by the core network element may be a core network identifier.

In some aspects, a network-side device may include an access network element. In this case, the identifier used inside the mobile communication system for the user equipment that is included in the start indication information received by the access network element may be an access network identifier.

S320: Perform tracing based on the identifier used inside the mobile communication system and the information about the specified content, and mark traced content with the tracing identifier. For example, tracing is performed based on the internal identifier in the mobile communication system and the content information that indicates the specified content. Traced content is marked with the tracing identifier.

S330: Transmit the marked content to the signaling tracing control device. For example, the marked content is transmitted to the signaling tracing control device.

In the technical solution in the aspect shown in FIG. 3, the traced content is marked with the tracing identifier of the user equipment. Thus, the signaling tracing control device may aggregate the traced content based on the tracing identifier. In addition, the network-side device does not need to perform tracing by adding the tracing identifier to interaction signaling, reducing additional signaling overheads caused inside a network during signaling tracing.

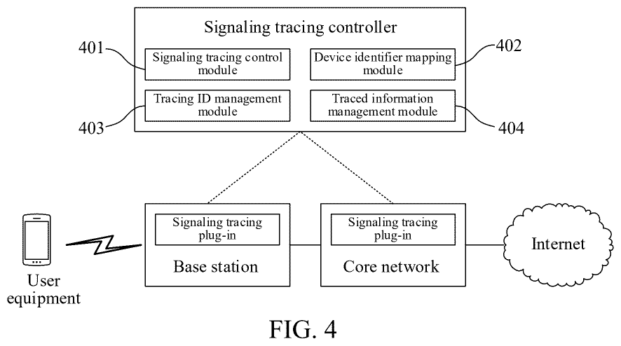

The technical solution in this aspect of this disclosure is described above from the perspectives of the signaling tracing control device and the network-side device separately. Implementation details of the technical solution in this aspect of this disclosure are described in detail below with reference to FIG. 4 to FIG. 7.

As shown in FIG. 4, user equipment needs to connect to the Internet through a base station (that is, an access network element) and a core network, and continuously performs signaling interaction with the base station and the core network after connecting to the Internet. A signaling tracing controller provided in this aspect of this disclosure controls and manages tracing of interaction signaling of the user equipment in a centralized manner by interacting with the base station and the core network, and by initiating, to the base station and the core network, a signaling tracing procedure, a procedure for obtaining a globally unique identity of a user and a globally unique temporary identity of the user, a procedure for updating the globally unique temporary identity of the user, and the like.

In an aspect of this disclosure, as shown in FIG. 4, the signaling tracing controller mainly includes four modules, including a signaling tracing control module 401, a device identifier mapping module 402, a tracing ID management module 403, and a traced information management module 404.

The signaling tracing control module 401 is responsible for providing a signaling tracing management interface externally, and is responsible for signaling tracing management. Through interaction with the tracing ID management module 403, a unique tracing ID corresponding to the user equipment is obtained. Through interaction with the device identifier mapping module 402, the globally unique identity (that is, a core network identifier) and the globally unique temporary identity (that is, an access network identifier) of the user are obtained. In addition, through interaction with the base station and the core network, tracing start and stop instructions are delivered to the base station and the core network, to trigger start and stop of equipment signal tracing. When updating of the globally unique temporary identity of the user is triggered during signaling tracing, the signaling tracing control module 401 is responsible for synchronously updating the globally unique temporary identity of the user to the base station.

The device identifier mapping module 402 is responsible for converting a transferred identifier used outside a mobile communication system (for example, a mobile phone number/a GPSI/an MSISDN) into the globally unique identity (for example, an IMSI or a SUPI) of the user and the globally unique temporary identity (for example, a GUTI or a 5G-GUTI) of the user. A main manner thereof is to obtain a mapping relationship between the identifier used outside the mobile communication system and the globally unique identity of the user through interaction with a core network element, for example, to obtain a mapping relationship between a mobile phone number/a GPSI/an MSISDN or the like and the globally unique identity (for example, an IMSI or a SUPI) of the user through interaction with an identifier mapping management network element (for example, a UDM/an HSS). If a user equipment identifier obtained by the signaling tracing controller upon receipt of a tracing request is an IMSI/a SUPI, the mapping operation may be skipped. Then, a mapping relationship with the globally unique temporary identity (for example, a GUTI or a 5G-GUTI) of the user is obtained through interaction with a network element for generating a globally unique temporary identity of a user (for example, an AMF/MME).

The tracing ID management module 403 is responsible for generating a globally unique tracing ID. The tracing ID is configured for identifying a tracing event initiated by a user. Information about the generated tracing ID is stored and transmitted to insides of the base station and the core network element that specifically perform signaling tracing.

The traced information management module 404 is responsible for pulling traced information from each core network element/base station, and aggregating and managing traced information with the same tracing ID (for example, sorting and combining traced events according to time of the traced events), during tracing or after tracing ends.

In addition, a signaling tracing plug-in may be integrated into the mobile communication system (for example, the core network element and the base station); and is configured to: receive tracing start/stop commands, trace a to-be-traced event and content of specified user equipment inside a network element, and store a traced event and content. In addition, a signaling tracing plug-in inside the network element for generating a globally unique temporary identity of a user is to be able to perceive a change in the globally unique temporary identity of the user, and notify the device identifier mapping module 402 to change the related identifier.

The following explains terms that occur in this aspect of this disclosure. The descriptions of the terms are provided as examples only and are not intended to limit the scope of the disclosure

A tracing ID is a globally unique ID generated by a tracing ID management module 403 in a signaling tracing controller for each tracing task. The tracing ID is carried in tracing initiation/end events and transmitted to a base station/core network element. During tracing of a related event of user equipment, the base station/core network element adds information about the tracing ID to a related traced event and content that are generated. In addition, traced events and content of the user equipment are generated, recorded, and stored by different network elements, and these network elements may be deployed in different locations in a distributed manner. As a result, the traced events and content of the user equipment are also stored in a distributed manner. Therefore, the tracing ID is also used as a key identifier to combine the traced events and content generated by the plurality of network elements.

A traced event and content are key information of a user traced and recorded by a network element in a mobile communication system during user equipment signaling tracing, and include a tracing ID, a globally unique identity (for example, an IMSI/a SUPI) of the user, a globally unique temporary identity (for example, a GUTI/5G-GUTI) of the user, traced information (for example, a protocol of concern for tracing, a specific protocol field of concern, whether to print logs, an exception, an alarm, a log level, and time of generating traced information), and a callback API.

An identifier used inside a mobile communication system is information configured for uniquely identifying user equipment. In a core network, a globally unique identity (for example, an IMSI/a SUPI) of a user is usually used to uniquely identify user equipment; and in a base station, a globally unique temporary identity (for example, a GUTI/5G-GUTI) of a user is usually used to uniquely identify a piece of user equipment.

Identifier used outside a mobile communication system: An identifier used inside a mobile communication system is usually difficult to be obtained by a common user. An identifier that is easy to be obtained is an identifier such as a GPSI/an MSISDN/a mobile phone number. However, this type of identifier usually cannot be directly used inside the mobile communication system. This type of identifier is an identifier used outside the mobile communication system.

A globally unique identity of a user is permanent ID information used by a core network element in a mobile communication system to identify the user. A SUPI is used as a globally unique identity of a user in a 5G system, and an IMSI is used as a globally unique identity of a user in a 4G system.

A globally unique temporary identity of a user is temporary ID information used by a base station network element in a mobile communication system to identify the user. A 5G-GUTI is used as a globally unique temporary identity of a user in a base station connected to a 5G core network (for example, a next generation NodeB (gNB)/a next generation evolved NodeB (ng-eNB)), and a GUTI is used as a globally unique temporary identity of a user in a base station connected to a 4G core network (for example, an evolved NodeB (eNB)/enhanced gNB (en-gNB)). The identity prevents user identity information from being exposed at an air interface.

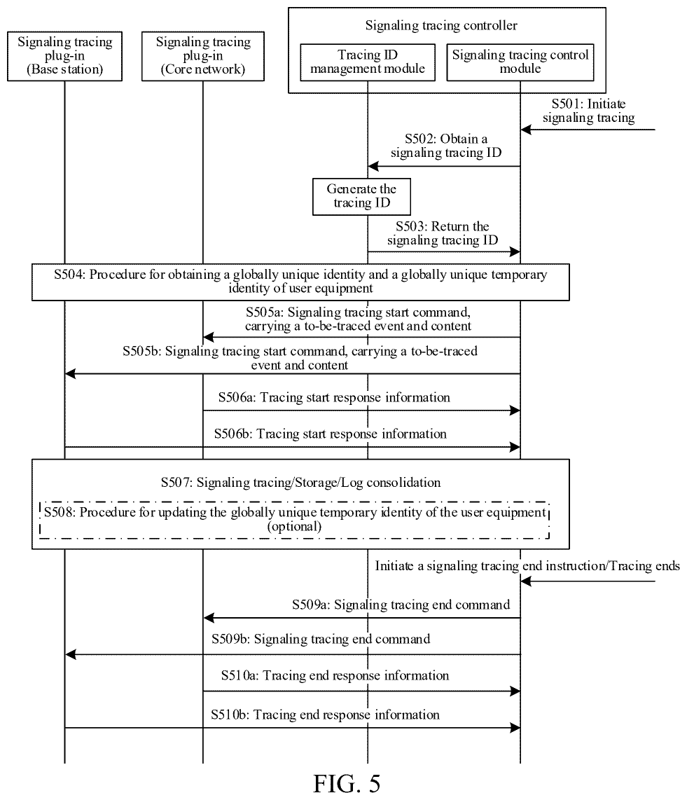

Based on the foregoing descriptions, a procedure of interaction between the signaling tracing controller and the base station and between the signaling tracing controller and the core network provided in this aspect of this disclosure is shown in FIG. 5, and includes the following operations:

S501: A user calls an API interface or a page to initiate a signaling tracing request to a signaling tracing control module, providing identifier information (for example, an IMSI/a SUPI/a mobile phone number/a GPSI/an MSISDN) of user equipment that needs to be traced, and specifying content to be traced (for example, signaling of concern, a field of specific signaling, or an event of concern, and whether detailed logs need to be printed, and a priority of logs to be printed). In some aspects, the signaling tracing request may further include a specified tracing time period, or only specifies to start tracing.

S502: The signaling tracing control module requests to obtain a signaling tracing ID specific to the user equipment from a tracing ID management module.

S503: The tracing ID management module generates and returns the globally unique tracing ID of the user equipment.

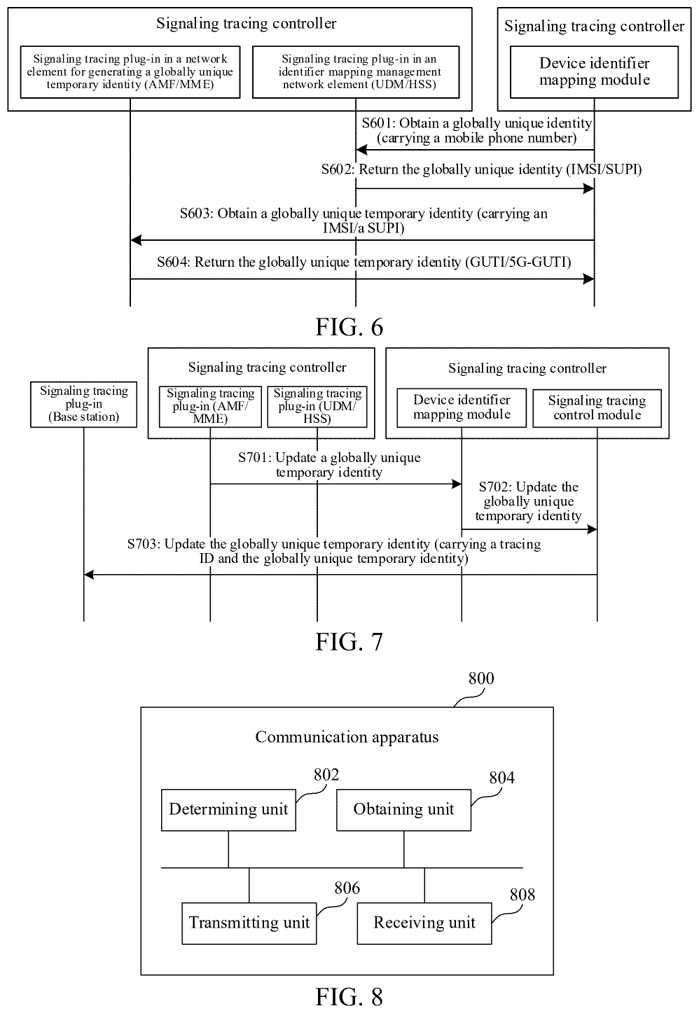

S504: A signaling tracing controller performs a procedure for obtaining a globally unique identity and a globally unique temporary identity of the user. For details, refer to an aspect shown in FIG. 6.

S505a: The signaling tracing control module initiates a signaling tracing start command to a signaling tracing plug-in integrated in a core network element (for example, an AMF/a session management function (SMF)/a UDM/a user plane function (UPF)/a policy control function (PCF) in a 5G system, or an MME/an HSS/a policy and charging rules function (PCRF) in a 4G system), carrying a to-be-traced event and content including the globally unique tracing ID, the globally unique identity (for example, an IMSI/a SUPI) of the user, and the content to be traced (for example, signaling of concern, a field of specific signaling, an event of concern, a log, an exception, or an alarm, and whether detailed logs need to be printed, and a priority of logs to be printed).

If the core network element receiving the start command is a network element responsible for generating a globally unique temporary identity of a user (for example, an AMF or an MME), the start command may additionally carry a callback API. Thus, after updating the globally unique temporary identity, the network element responsible for generating a globally unique temporary identity of a user notifies the signaling tracing controller to update the identifier.

S505b: The signaling tracing control module initiates a signaling tracing start command to a signaling tracing plug-in integrated in a base station, carrying a to-be-traced event and content including the globally unique tracing ID, the globally unique temporary identity (for example, a GUTI/5G-GUTI) of the user, and the content to be traced (for example, signaling of concern, a field of specific signaling, an event of concern, a log, an exception, or an alarm, and whether detailed logs need to be printed, and a priority of logs to be printed).

S506a: A core network responds to a tracing request triggered in S505a.

S506b: The base station responds to a tracing request triggered in S505b.

S507: Signaling of the user equipment starts to be traced inside the core network and the base station; and traced information is added with labels such as the tracing ID and event, and then stored (for example, stored in a location such as a file on a disk or a database). During tracing/after tracing ends, a traced information management module pulls traced information from each core network element/base station, and aggregates and manages the traced information (for example, sorts and combines traced events according to time of the traced events).

S508: If tracing the signaling of the user equipment lasts for a long time, a globally unique temporary identity (for example, a GUTI/5G-GUTI) may be reallocated to the user because the user goes online or offline, that is, the network element for generating a globally unique temporary identity of a user (for example, an AMF or an MME) reallocates the globally unique temporary identity to the user. In this case, a signaling tracing plug-in integrated in the network element triggers a procedure for updating the globally unique temporary identity of the user. For details of the procedure, refer to an aspect shown in FIG. 7.

S509a and S509b: After tracing time ends or an administrator proactively triggers a tracing end instruction, the signaling tracing control module transmits, to the core network and the base station, signaling tracing end commands, which carry the tracing ID and instruct to end tracing.

S510a and S510b: The core network/base station respond to the tracing end commands, and stop signaling tracing.

On a mobile communication network, user equipment has a lot of identifiers, such as a mobile phone number/a GPSI/an MSISDN/an international mobile equipment identity (IMEI)/an IMSI/a SUPI/a GUTI/a 5G-GUITI. Identifier information that is related and obtained by user equipment includes a GPSI/an MSISDN/a mobile phone number and the like. However, a globally unique identity (for example, an IMSI/a SUPI) of a user is usually used in a core network to identify the user, and a globally unique temporary identity (for example, a GUTI/5G-GUTI) is usually used in a base station to identify a user. A mapping relationship between a globally unique identity of a user and a mobile phone number/a GPSI/an MSISDN or the like is managed by a network element responsible for identifier mapping management (for example, a UDM on a 5G network, or an HSS on a 4G network). A globally unique temporary identity of a user is generated and managed by a network element for generating a globally unique temporary identity (for example, an AMF on a 5G network, or an MME on a 4G network).

Therefore, when initiating a signaling tracing procedure, a signaling tracing controller is to provide, for the base station and the core network, user identifiers that can be recognized by the base station and the core network, so that tracing can be initiated successfully. However, these internal identifiers are usually quite difficult to be obtained by a user. Identifier information that a user can easily obtain is information such as a mobile phone number/a GPSI/an MSISDN. Therefore, the device identifier mapping module in the signaling tracing controller provided in this aspect of this disclosure may obtain a globally unique identity (for example, an IMSI/a SUPI) of a user and a globally unique temporary identity of the user according to information, such as a mobile phone number/a GPSI/an MSISDN, provided by the user. Specifically, with reference to FIG. 6, the following operations are included:

S601: A device identifier mapping module requests a globally unique identity (for example, an IMSI/a SUPI) of a user of to-be-traced user equipment from a signaling tracing plug-in in an identifier mapping management network element (for example, a UDM/an HSS), where a request carries identifier information (for example, mobile phone number/GPSI/MSISDN/IMSI/SUPI information) of the user equipment. If a signaling tracing controller already stores the globally unique identity (for example, an IMSI/a SUPI) of the user or the identifier provided by the user is an IMSI/a SUPI, S602 may be omitted.

S602: The signaling tracing plug-in in the identifier mapping management network element queries an identifier mapping relationship inside the network element, and returns the globally unique identity (for example, an IMSI/a SUPI) of the user.

S603: The device identifier mapping module requests a globally unique temporary identity of the user from a signaling tracing plug-in in a network element for generating a globally unique temporary identity (for example, an AMF/MME), where a request carries the globally unique identity (for example, an IMSI/a SUPI) of the user.

S604: The signaling tracing plug-in in the network element for generating a globally unique temporary identity (for example, an AMF/MME) returns the globally unique temporary identity (for example, a GUTI/5G-GUTI) of the user.

In an aspect of this disclosure, if tracing the signaling of the user equipment lasts for a long time, the globally unique temporary identity (for example, a GUTI/5G-GUTI) may be reallocated to the user because the user goes online or offline. If the network element for generating a globally unique temporary identity of a user (for example, an AMF or an MME) reallocates the globally unique temporary identity to the user, the signaling tracing plug-in in the network element is to trigger the procedure for updating the globally unique temporary identity of the user. Specifically, with reference to FIG. 7, the following operations are included:

S701: A network element for generating a globally unique temporary identity (for example, an AMF or an MME) reallocates a globally unique temporary identity to a user, and a signaling tracing plug-in in the network element notifies a device identifier mapping module to update a globally unique temporary identity (for example, a GUTI or a 5G-GUTI) of the user, carrying a globally unique tracing ID and the updated globally unique temporary identity of the user.

S702: The device identifier mapping module performs updating, stores the updated globally unique temporary identity of the user, and notifies a signaling tracing control module, carrying the globally unique tracing ID and the updated globally unique temporary identity of the user.

S703: The signaling tracing control module notifies a signaling tracing plug-in in a base station network element to update tracing information, carrying the globally unique tracing ID and the updated globally unique temporary identity of the user. After receiving the update notification, the base station performs tracing by using the new globally unique temporary identity of the user as a tracing basis.

The foregoing aspect of this disclosure provides the new user signaling tracing solution to provide, for the user equipment in the mobile communication network, a signaling tracing service, which may be configured for recording and storing new information, such as a signaling field, a log, an exception, or an alarm, of the user equipment. Operation and maintenance personnel may utilize the information to find out a cause of a fault, such as a high call drop rate, a handover failure, or a traffic exception.

In addition, in the foregoing aspect of this disclosure, the signaling tracing controller is used to generate tracing IDs and manage signaling tracing information in a centralized manner. The tracing ID and the tracing information for user signaling tracing are transmitted to the network element only when signaling tracing is initiated and ended for the user equipment. According to the method for managing tracing IDs and consolidating tracing information in a centralized manner, the necessary tracing information configuration is delivered to the network element only when the tracing start and stop instructions are delivered. This can reduce additional signaling overheads caused inside the core network by signaling tracing. Moreover, this aspect of this disclosure further provides the method for mapping the user identifier used outside and the user identifier used inside the mobile communication system, and the identifier update method. The device identifier mapping module in the signaling tracing controller interacts with the network element in the core network, to convert the user identifier used outside the mobile communication system (for example, a mobile phone number/a GPSI/an MSISDN) into the user identifier used inside the mobile communication system (for example, an IMSI/a SUPI/a GUTI/a 5G-GUTI). This can significantly improve system availability. Besides, the method for updating the globally unique temporary identity of the user is provided to prevent a traced event and content from being missed.

The following describes apparatus aspects of this disclosure, and the apparatus aspects may be used for performing the communication methods in the foregoing aspect of this disclosure. For details not disclosed in the apparatus aspects of this disclosure, refer to the foregoing communication method aspect of this disclosure.

FIG. 8 is a block diagram of a communication apparatus 800 according to an aspect of this disclosure. The communication apparatus 800 may be disposed in a signaling tracing control device.

With reference to FIG. 8, the communication apparatus 800 according to this aspect of this disclosure includes a determining unit 802, an obtaining unit 804, a transmitting unit 806, and a receiving unit 808.

The determining unit 802 is configured to: when a signaling tracing request specific to user equipment is received, determine a tracing identifier corresponding to the user equipment, the signaling tracing request being configured for tracing specified content of the user equipment in a mobile communication system. The obtaining unit 804 is configured to obtain an identifier used inside the mobile communication system for the user equipment. The transmitting unit 806 is configured to transmit start indication information to a network-side device, the start indication information including the tracing identifier, the identifier used inside the mobile communication system, and information about the specified content, and the start indication information being configured for starting signaling tracing. The receiving unit 808 is configured to receive content from the network-side device, the content being obtained through tracing that is performed based on the identifier used inside the mobile communication system and the information about the specified content, and being marked with the tracing identifier.

In some aspects of this disclosure, based on the foregoing solution, the identifier used inside the mobile communication system includes a core network identifier. The obtaining unit 804 is configured to: transmit a core network identifier obtaining request to an identifier mapping management network element in a core network based on an identifier used outside the mobile communication system for the user equipment; and receive the core network identifier from the identifier mapping management network element, the core network identifier being returned in response to the core network identifier obtaining request.

In some aspects of this disclosure, based on the foregoing solution, the identifier used inside the mobile communication system further includes an access network identifier. The obtaining unit 804 is configured to: after the core network identifier is obtained, transmit an access network identifier obtaining request to an access network identifier generating network element based on the core network identifier; and receive the access network identifier from the access network identifier generating network element, the access network identifier being returned in response to the access network identifier obtaining request.

In some aspects of this disclosure, based on the foregoing solution, the transmitting unit 806 is configured to transmit the start indication information to a core network element, the identifier used inside the mobile communication system including a core network identifier.

In some aspects of this disclosure, based on the foregoing solution, the transmitting unit 806 is configured to transmit the start indication information of signaling tracing to an access network element, the identifier used inside the mobile communication system including an access network identifier.

In some aspects of this disclosure, based on the foregoing solution, the identifier used inside the mobile communication system includes a core network identifier and an access network identifier. The transmitting unit 806 is configured to: transmit first start indication information to a core network element, the first start indication information including the tracing identifier, the core network identifier, and the information about the specified content; and transmit second start indication information to an access network element, the second start indication information including the tracing identifier, the access network identifier, and the information about the specified content.

In some aspects of this disclosure, based on the foregoing solution, if the core network element is an access network identifier generating network element, the first start indication information further includes a callback address, and the callback address is configured for: after the core network element reallocates the access network identifier to the user equipment, feeding back the reallocated access network identifier.

In some aspects of this disclosure, based on the foregoing solution, the receiving unit 808 is further configured to receive the access network identifier from the access network identifier generating network element, the access network identifier being reallocated to the user equipment; the determining unit 802 is further configured to generate a tracing information update message, the tracing information update message including the tracing identifier and the reallocated access network identifier; and the transmitting unit 806 is further configured to transmit the tracing information update message to the access network element, the tracing information update message being configured for indicating to trace the specified content of the user equipment based on the reallocated access network identifier.

In some aspects of this disclosure, based on the foregoing solution, the communication apparatus 800 further includes an aggregation unit, configured to: after the content traced by the network-side device based on the start indication information is received, aggregate the traced content according to a set aggregation policy, the aggregation policy including at least one of the following: aggregation based on the tracing identifier, or sorting of the traced content by time.

In some aspects of this disclosure, based on the foregoing solution, the signaling tracing request includes information about a tracing time period. The transmitting unit 806 is configured to: transmit the start indication information to the network-side device before the tracing time period starts.

In some aspects of this disclosure, based on the foregoing solution, the transmitting unit 806 is further configured to: when a tracing end instruction specific to the user equipment is received, or when the tracing time period ends, transmit end indication information to the network-side device, the end indication information including the tracing identifier, and the end indication information being configured for ending signaling tracing.

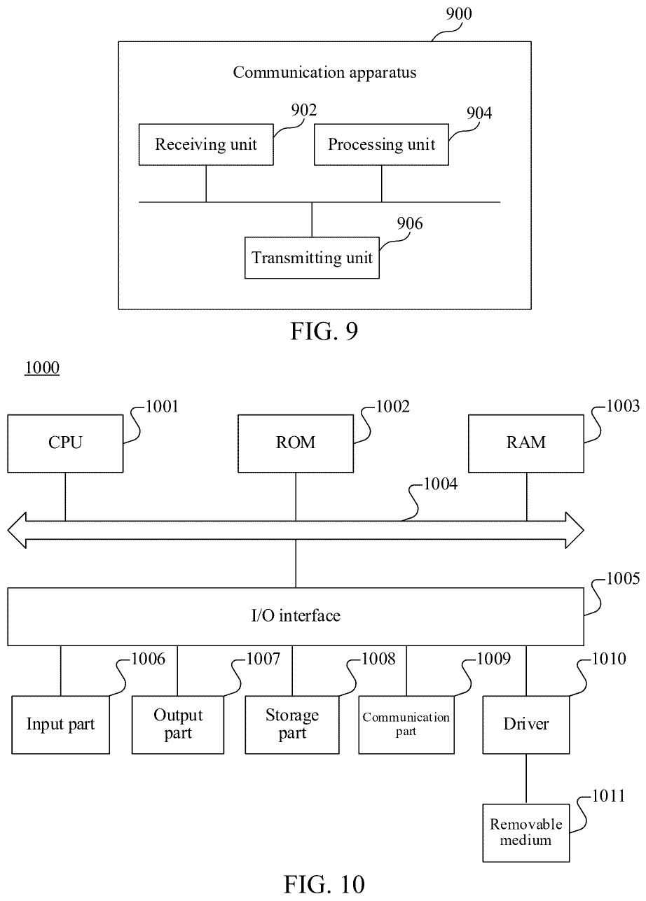

FIG. 9 is a block diagram of a communication apparatus 900 according to an aspect of this disclosure. The communication apparatus 900 may be disposed in a network-side device.

With reference to FIG. 9, the communication apparatus 900 according to this aspect of this disclosure includes a receiving unit 902, a processing unit 904, and a transmitting unit 906.

The receiving unit 902 is configured to receive start indication information transmitted from a signaling tracing control device, the start indication information including a tracing identifier of user equipment, an identifier used inside a mobile communication system for the user equipment, and information about specified content to be traced, and the start indication information being configured for starting signaling tracing.

The processing unit 904 is configured to: perform tracing based on the identifier used inside the mobile communication system and the information about the specified content, and mark traced content with the tracing identifier.

The transmitting unit 906 is configured to transmit the marked content to the signaling tracing control device.

FIG. 10 is a diagram of a structure of a computer system 1000 adapted to implement an electronic device according to an aspect of this disclosure.

The computer system 1000 of the electronic device shown in FIG. 10 is merely an example, and does not constitute any limitation on functions and a use scope of the aspects of this disclosure.

As shown in FIG. 10, the computer system 1000 includes processing circuitry, such as a central processing unit (CPU) 1001, which may perform various suitable actions and processing based on a program stored in a read-only memory (ROM) 1002 (e.g., a non-transitory computer-readable storage medium) or a program loaded from a storage part 1008 into a random access memory (RAM) 1003, for example, perform the methods described in the foregoing aspect. The RAM 1003 further stores various programs and data required for system operations. The CPU 1001, the ROM 1002, and the RAM 1003 are connected to each other by using a bus 1004. An input/output (I/O) interface 1005 is also connected to the bus 1004.

The following components are connected to the I/O interface 1005: an input part 1006 including a keyboard, a mouse, and the like; an output part 1007 including a cathode ray tube (CRT), a liquid crystal display (LCD), a speaker, or the like; the storage part 1008 including a hard disk or the like; and a communication part 1009 including a network interface card such as a local area network (LAN) card or a modem. The communication part 1009 performs communication processing by using a network such as the Internet. A driver 1010 is also connected to the I/O interface 1005 as required. A removable medium 1011, such as a magnetic disk, an optical disc, a magneto-optical disk, or a semiconductor memory, is installed on the drive 1010 as required, so that a computer program read from the removable medium 1011 is installed into the storage part 1008 as required.

Particularly, according to an aspect of this disclosure, the foregoing processes described with reference to the flowcharts may be implemented as computer software programs. For example, an aspect of this disclosure includes a computer program product. The computer program product includes a computer program stored in a computer-readable medium such as a non-transitory computer-readable storage medium. The computer program includes a computer program configured for performing a method shown in a flowchart. In such an aspect, the computer program may be downloaded from the network through the communication part 1009 and installed, and/or installed from the removable medium 1011. When the computer program is executed by the CPU 1001, the various functions defined in the system of this disclosure are performed.

The computer-readable medium described in this aspect of this disclosure may be a computer-readable signal medium, or a computer-readable storage medium, or any combination of the above. The computer-readable storage medium may be, for example, but is not limited to, an electric, magnetic, optical, electromagnetic, infrared, or semiconductive system, apparatus, or component, or any combination of the above. A more specific example of the computer-readable storage medium may include but is not limited to an electrical connection having one or more wires, a portable computer disk, a hard disk, a RAM, a ROM, an erasable programmable ROM (EPROM), a flash memory, an optical fiber, a portable compact disk ROM (CD-ROM), an optical storage device, a magnetic storage device, or any appropriate combination of the above. In this disclosure, the computer-readable storage medium may be any tangible medium including or storing a program, and the program may be used by or used in conjunction with an instruction execution system, an apparatus, or a device. In this disclosure, the computer-readable signal medium may include a data signal transmitted in a baseband or as part of a carrier, and has a computer-readable computer program carried therein. A data signal propagated in such a way may assume a plurality of forms, including, but not limited to, an electromagnetic signal, an optical signal, or any appropriate combination of the above. The computer-readable signal medium may further be any computer-readable medium other than a computer-readable storage medium. The computer-readable medium may transmit, propagate, or transfer a program that is used by or used in conjunction with an instruction execution system, an apparatus, or a device. The computer program included in the computer-readable medium may be transmitted by using any appropriate medium, including but not limited to a wireless medium, a wired medium, or any appropriate combination of the above.

The flowcharts and block diagrams in the accompanying drawings illustrate possible system architectures, functions, and operations that may be implemented by the system, the methods, and the computer program product according to the aspects of this disclosure. Each box in a flowchart or a block diagram may represent a module, a program segment, or a part of code. The module, the program segment, or the part of code includes one or more executable instructions configured for implementing specified logical functions. In some implementations used as substitutes, functions annotated in boxes may alternatively occur in a sequence different from that annotated in an accompanying drawing. For example, two boxes shown in succession may actually be performed basically in parallel, and sometimes the two boxes may alternatively be performed in a reverse sequence. This is determined by a related function. Each box in a block diagram or a flowchart and a combination of boxes in the block diagram or the flowchart may be implemented by using a dedicated hardware-based system that performs a specified function or operation, or may be implemented by using a combination of dedicated hardware and a computer program.

A related unit described in the aspects of this disclosure may be implemented in a software manner, or may be implemented in a hardware manner. The unit described may also be set in a processor. A name of the unit does not constitute a limitation on the unit in a specific case.

In another aspect, this disclosure further provides a computer-readable medium. The computer-readable medium may be included in the electronic device described in the foregoing aspects, or may exist alone without being installed into the electronic device. The computer-readable medium carries one or more computer programs. The one or more computer programs, when executed by the electronic device, cause the electronic device to implement the methods described in the foregoing aspects.

Although a plurality of modules or units of a device configured to perform actions are discussed in the foregoing detailed descriptions, such division is not mandatory. Actually, according to the implementations of this disclosure, the features and functions of two or more modules or units described above may be specifically implemented in one module or unit. On the contrary, the features and functions of one module or unit described above may be further divided to be specifically implemented by a plurality of modules or units.

According to the foregoing descriptions of the implementations, a person skilled in the art may readily understand that the example implementations described herein may be implemented by using software, or may be implemented by combining software and necessary hardware. Therefore, the technical solutions according to the implementations of this disclosure may be implemented in a form of a software product. The software product may be stored in a non-volatile storage medium (which may be a CD-ROM, a USB flash drive, a removable hard disk, or the like) or on a network, including several instructions for instructing a computing device (which may be a personal computer, a server, a touch terminal, a network device, or the like) to perform the methods according to the implementations of this disclosure.

After considering the specification and practicing the implementations disclosed herein, a person skilled in the art may conceive of other implementations of this disclosure. This disclosure is intended to cover any variations, uses, or adaptive changes of this disclosure. These variations, uses, or adaptive changes follow the general principles of this disclosure and include common general knowledge or common technical means in the art, which are not disclosed in this disclosure.

This disclosure is not limited to the precise structures described above and shown in the accompanying drawings, and various modifications and changes can be made without departing from the scope of this disclosure.

What is claimed is:

1. A communication method, comprising:
receiving a signaling tracing request to trace specified content of user equipment in a mobile communication system;
determining a tracing identifier of the user equipment associated with the signaling tracing request;
obtaining an internal identifier in the mobile communication system for the user equipment;
transmitting start indication information to a network-side device, the start indication information including the tracing identifier, the internal identifier in the mobile communication system, and content information that indicates the specified content, and the start indication information initiating signaling tracing; and
receiving, from the network-side device, content that is traced based on the internal identifier in the mobile communication system and the specified content, the content being marked with the tracing identifier.

2. The method according to claim 1, wherein the internal identifier in the mobile communication system includes a core network identifier, and the obtaining comprises:
transmitting a core network identifier obtaining request to an identifier mapping management network element in a core network, the core network identifier obtaining request being based on an external identifier that is used outside the mobile communication system for the user equipment; and
receiving the core network identifier returned by the identifier mapping management network element based on the core network identifier obtaining request.

3. The method according to claim 2, wherein the internal identifier in the mobile communication system includes an access network identifier, and the method further comprises:
after the core network identifier is obtained, transmitting an access network identifier obtaining request to an access network identifier generating network element based on the core network identifier; and
receiving the access network identifier returned by the access network identifier generating network element based on the access network identifier obtaining request.

4. The method according to claim 1, wherein the transmitting comprises:
transmitting the start indication information to a core network element, the internal identifier in the mobile communication system including a core network identifier.

5. The method according to claim 1, wherein the transmitting comprises:
transmitting the start indication information to an access network element, the internal identifier in the mobile communication system including an access network identifier.

6. The method according to claim 1, wherein the internal identifier in the mobile communication system includes a core network identifier and an access network identifier, and the transmitting the start indication information to the network-side device comprises:
transmitting first start indication information to a core network element, the first start indication information including the tracing identifier, the core network identifier, and the content information that indicates the specified content; and
transmitting second start indication information to an access network element, the second start indication information including the tracing identifier, the access network identifier, and the content information that indicates the specified content.

7. The method according to claim 6, wherein when the core network element is an access network identifier generating network element, the first start indication information further includes a callback address configured to receive a reallocated access network identifier after the core network element reallocates the access network identifier to the user equipment.

8. The method according to claim 7, further comprising:
receiving, from the access network identifier generating network element, the access network identifier reallocated to the user equipment;
generating a tracing information update message, the tracing information update message including the tracing identifier and the reallocated access network identifier; and
transmitting the tracing information update message to the access network element, the tracing information update message indicating the signaling tracing of the specified content is to be based on the reallocated access network identifier.

9. The method according to claim 1, further comprising:
aggregating the traced content based on a aggregation policy, the aggregation policy including at least one of:
aggregating the traced content based on the tracing identifier; or
sorting the traced content by time.

10. The method according to claim 1, wherein
the signaling tracing request includes a tracing time period, and the start indication information is transmitted before the tracing time period starts.

11. The method according to claim 10, further comprising:
receiving a tracing end instruction specific to the user equipment, or detecting that the tracing time period ends; and
transmitting end indication information to the network-side device, the end indication information including the tracing identifier and causing the network-side device to end the signaling tracing.

12. A communication method, comprising:
receiving start indication information from a signaling tracing control device, the start indication information including a tracing identifier of user equipment, an internal identifier in a mobile communication system for the user equipment, and content information that indicates specified content of the user equipment to be traced;
performing tracing based on the internal identifier in the mobile communication system and the content information that indicates the specified content;
marking traced content with the tracing identifier; and
transmitting the marked content to the signaling tracing control device.

13. A communication apparatus, comprising:
processing circuitry configured to:
receive a signaling tracing request to trace specified content of user equipment in a mobile communication system;
determine a tracing identifier of the user equipment associated with the signaling tracing request;
obtain an internal identifier in the mobile communication system for the user equipment;
transmit start indication information to a network-side device, the start indication information including the tracing identifier, the internal identifier in the mobile communication system, and content information that indicates the specified content, and the start indication information initiating signaling tracing; and
receive, from the network-side device, content that is traced based on the internal identifier in the mobile communication system and the specified content, the content being marked with the tracing identifier.

14. The apparatus according to claim 13, wherein
the internal identifier in the mobile communication system includes a core network identifier, and
the processing circuitry is configured to:
transmit a core network identifier obtaining request to an identifier mapping management network element in a core network, the core network identifier obtaining request being based on an external identifier that is used outside the mobile communication system for the user equipment; and
receive the core network identifier returned by the identifier mapping management network element based on the core network identifier obtaining request.

15. The apparatus according to claim 14, wherein
the internal identifier in the mobile communication system includes an access network identifier, and
the processing circuitry is configured to:
after the core network identifier is obtained, transmit an access network identifier obtaining request to an access network identifier generating network element based on the core network identifier; and
receive the access network identifier returned by the access network identifier generating network element based on the access network identifier obtaining request.

16. The apparatus according to claim 13, wherein the processing circuitry is configured to:
transmit the start indication information to a core network element, the internal identifier in the mobile communication system including a core network identifier.

17. The apparatus according to claim 13, wherein the processing circuitry is configured to:
transmit the start indication information to an access network element, the internal identifier in the mobile communication system including an access network identifier.

18. The apparatus according to claim 13, wherein
the internal identifier in the mobile communication system includes a core network identifier and an access network identifier, and
the processing circuitry is configured to:
transmit first start indication information to a core network element, the first start indication information including the tracing identifier, the core network identifier, and the content information that indicates the specified content; and
transmit second start indication information to an access network element, the second start indication information including the tracing identifier, the access network identifier, and the content information that indicates the specified content.

19. The apparatus according to claim 18, wherein when the core network element is an access network identifier generating network element, the first start indication information further includes a callback address configured to receive a reallocated access network identifier after the core network element reallocates the access network identifier to the user equipment.

20. The apparatus according to claim 18, wherein the processing circuitry is configured to:
receive, from the access network identifier generating network element, the access network identifier reallocated to the user equipment;
generate a tracing information update message, the tracing information update message including the tracing identifier and the reallocated access network identifier; and
transmit the tracing information update message to the access network element, the tracing information update message indicating the signaling tracing of the specified content is to be based on the reallocated access network identifier.
